(19) United States
(12) Patent Application Publication
(10) Pub. No.: US 2006/0118598 A1
(43) Pub. Date: Jun. 8, 2006

(54) Bonding apparatus and bonding method

(75) Inventors: Yusuke Chikamori, Ohta-ku (JP); Naoaki Ogure, Ohta-ku (JP); Hideki Tateishi, Ohta-ku (JP); Yukio Fukunaga, Ohta-ku (JP); Hiroyuki Ueyama, Yokohama-shi (JP)

Correspondence Address: BROWDY AND NEIMARK, P.L.L.C.;624 NINTH STREET, NW, SUITE 300, WASHINGTON, DC, 20001-5303, US

(73) Assignee: EBARA CORPORATION, Ohta-ku (JP)

(21) Appl. No.: 11/291,838

(22) Filed: Dec. 2, 2005

(30) Foreign Application Priority Data
Dec. 2, 2004 (JP) 2004-349454
Nov. 17, 2005 (JP) 2005-332752

(51) Int. Cl. B23K 1/00; B23K 5/00; B23K 20/14

(52) U.S. Cl. 228/42; 228/218; 228/220

(57) ABSTRACT

A bonding apparatus can bond contacts of electronic components directly to each other without the need for solder. The bonding apparatus include a hermetically sealed processing chamber, a plurality of bases for holding at least two workpieces having respective bonding regions in the processing chamber, a gas inlet for introducing a processing gas to clean the bonding regions into the processing chamber, a pressure controller for controlling a predetermined pressure to be developed in the processing chamber, a heater for heating the workpieces in the processing chamber, and a bonding unit for pressing and bonding the bonding regions of the workpieces to each other in the processing chamber.

### BACKGROUND OF THE INVENTION

1. Field of the Invention

The present invention relates to an apparatus for and a method of electrically bonding electronic components, for example.

2. Description of the Related Art

One device used in fabricating highly integrated semiconductor devices is an interposer module comprising a semiconductor substrate and an interposer substrate that are stacked together. Heretofore, it has been customary to electrically connect such an interposer module with bumps of lead solder formed on contacts. However, efforts have been made in the art to eliminate lead solder for the purpose of reducing environmental burdens. In addition, there have been needs in the art for solder-free bonding to achieve cost reductions by way of material and process cutbacks.

According to a reported solder-free bonding process, a bonding surface of a semiconductor component or the like is physically or chemically cleaned to activate an atomic layer thereof, and then pressed against an object to be joined under a pressure in the range from several tens to several hundreds MPa. The bonding surface may be physically cleaned by a dry process such as a sputtering process in which energy particles are forced to impinge on the bonding surface in a vacuum. The bonding surface may be chemically cleaned by a wet process using a chemical solution such as of an inorganic acid or an organic acid. For details, reference should be made to Japanese laid-open patent publication No. H11-233934 and Tadatomo Suga “The Possibility of Room Temperature Joining”, Welding Society, 1992, Vol. 61, No. 2, pages 98 through 106.

### SUMMARY OF THE INVENTION

The conventional bonding processes have been problematic for the following reasons: According to the sputtering process in which energy particles are forced to impinge on the bonding surface in a vacuum, since the bonding surface of a semiconductor component or the like needs to be treated at a high temperature, the semiconductor component or the like tends to be deteriorated. In addition, the bonding surface is liable to be easily oxidized again, for example, when it is transferred from the cleaning process to the next pressing process. Furthermore, it is difficult to perform the sputtering process and the pressing process in one apparatus as the sputtering process is performed in the vacuum.

The wet process using a chemical solution requires the bonding surface to be dried after it has been cleaned. When the bonding surface is dried, it may possibly be deteriorated. It is also difficult to perform the wet process and the pressing process in one apparatus.

The present invention has been made in view of the above drawbacks. It is therefore an object of the present invention to provide an apparatus for and a method of bonding contacts of electronic components directly to each other without the need for solder.

In order to achieve the above object, the present invention provides a bonding apparatus comprising a hermetically sealed processing chamber, a plurality of bases for holding at least two workpieces having respective bonding regions in the processing chamber, a gas inlet for introducing a processing gas to clean the bonding regions into the processing chamber, a pressure controller for controlling a predetermined pressure to be developed in the processing chamber, a heater for heating the workpieces in the processing chamber, and a bonding unit for pressing and bonding the bonding regions of the workpieces to each other in the processing chamber.

According to the present invention, after the surfaces of the bonding regions of the workpieces are cleaned with the processing gas in the processing chamber, the bonding regions of the workpieces are pressed and bonded to each other in the same processing chamber. Therefore, the workpieces can be bonded for a strong, highly durable bond while the cleaned surfaces of the bonding regions are being prevented from being deteriorated by oxidization and contamination.

In a preferred aspect of the present invention, the bonding apparatus has a positioning mechanism disposed in the processing chamber for positioning the bonding regions with respect to each other. The positioning mechanism allows the bonding regions to be finally positioned and accurately bonded to each other.

In a preferred aspect of the present invention, the positioning mechanism comprises a position detector for detecting positions of the workpieces held by the bases, and a position corrector for correcting the positions of the workpieces based on the positions detected by the position detector. Therefore, the bonding regions can be bonded to each other after the positions thereof are confirmed.

In a preferred aspect of the present invention, the bonding apparatus further comprises at least one preliminary chamber, disposed adjacent to the processing chamber, for transferring the workpieces between an atmospheric environment and the processing chamber without exposing the processing chamber to the atmospheric environment.

Alternatively, the bonding apparatus may further comprise a positioning mechanism disposed outside of the processing chamber for positioning the bonding regions with respect to each other. The positioning mechanism disposed outside of the processing chamber allows the bonding regions to be positioned more easily.

The present invention provides another bonding apparatus comprising a cleaning unit for holding at least two workpieces having respective bonding regions in a hermetically sealed processing chamber and introducing a processing gas into the processing chamber to clean the bonding regions, a bonding unit for pressing and bonding the bonding regions of the workpieces to each other in the processing chamber, and a loading unit for loading the workpieces from the cleaning unit into the bonding unit in the processing chamber.

In a preferred aspect of the present invention, the processing gas comprises an organic acid gas such as a formic acid gas or an acetic acid gas, and the bonding regions are cleaned at a temperature ranging from 100 to 300° C., and bonded at a temperature ranging from 120 to 300° C.

Since the formic acid is capable of reducing an oxide film on a copper surface, for example, and the acetic acid is capable of etching an oxide film on a copper surface, they are effective in removing an oxide film on a metal surface. Since the temperature for the formic acid and the acetic acid to process the oxide film is low, the workpieces, which are sensitive to temperatures, can be processed without being deteriorated.

The bonding regions are preferably cleaned under a pressure of at least 40 Pa developed in the processing chamber.

In a preferred aspect of the present invention, the processing gas comprises an organic acid and an inactive gas, and the bonding regions are cleaned under a substantially atmospheric pressure with the processing gas including the organic acid gas having a pressure of 40 Pa in the processing chamber.

Preferably, the bonding regions are cleaned and bonded at substantially the same temperature.

The bonding regions are preferably bonded under a pressure of at least e.g. 14 Mpa.

The bonding regions may be made of copper, oxide copper, or a copper alloy.

The present invention provides a bonding method comprising loading at least two bonding workpieces having respective bonding regions into a processing chamber, heating the workpieces in the processing chamber and introducing a processing gas into the processing chamber to clean the bonding regions, and then pressing and bonding the bonding regions of the workpieces to each other in the processing chamber.

The above and other objects, features, and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic view showing a preparatory process of a bonding apparatus according to a first embodiment of the present invention;

FIG. 2 is a schematic view showing a cleaning process of the bonding apparatus according to the first embodiment of the present invention;

FIG. 3 is a schematic view showing a bonding process of the bonding apparatus according to the first embodiment of the present invention;

FIG. 4 is a graph showing the relationship between the bonding pressure and the shear fracture force in the bonding apparatus according to the first embodiment of the present invention;

FIG. 5 is a schematic view showing a preparatory process of a bonding apparatus according to a second embodiment of the present invention;

FIG. 6 is a schematic view showing a cleaning process of the bonding apparatus according to the second embodiment of the present invention; and

FIG. 7 is a schematic view showing a bonding process of the bonding apparatus according to the second embodiment of the present invention.

### DETAILED DESCRIPTION OF THE PREFERRED EMBODIMENTS

Embodiments of the present invention will be described in detail below with reference to the drawings.

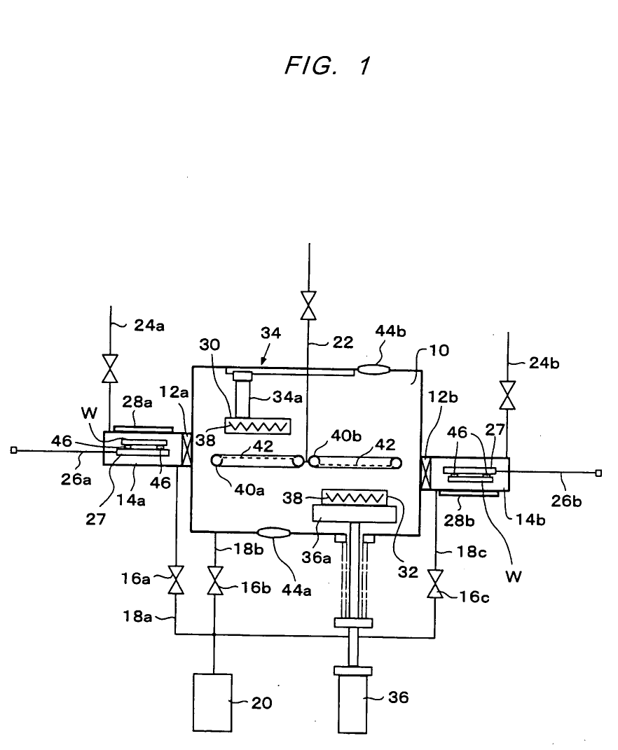

FIGS. 1 through 3 schematically show a bonding apparatus according to a first embodiment of the present invention. The bonding apparatus according to the first embodiment of the present invention is used to bond a semiconductor chip and an interposer to each other, for example.

As shown in FIGS. 1 through 3, the bonding apparatus has a processing chamber 10 and a pair of preliminary chambers 14a, 14b disposed adjacent to respective left and right walls of the processing chamber 10 with respective gate valves 12a, 12b interposed therebetween. The left preliminary chamber 14a as viewed in FIGS. 1 through 3 is also referred to as a first preliminary chamber 14a, and the right preliminary chamber 14a as viewed in FIGS. 1 through 3 is also referred to as a second preliminary chamber 14b. The processing chamber 10 and the preliminary chambers 14a, 14b are connected to an evacuating device 20, as a pressure controller, through evacuating pipes 18a, 18b, 18c having respective on-off valves 16a, 16b, 16c. The evacuating device 20 is capable of controlling the pressures in the processing chamber 10 and the preliminary chambers 14a, 14b at certain values based on pressure values indicated by pressure sensors (not shown). The bonding apparatus has a processing gas inlet pipe 22, to be described later, connected to the processing chamber 10, and a pair of gas inlet pipes 24a, 24b, connected to the respective preliminary chambers 14a, 14b, for introducing an inactive gas into the preliminary chambers 14a, 14b. The preliminary chambers 14a, 14b are associated with respective loading arms 26a, 26b for bringing workpieces W, to be processed, into and out of the processing chamber 10 through the gate valves 12a, 12b, and respective doors 28a, 28b which, when opened, allow workpieces W to be transferred to the loading arms 26a, 26b. Each of the loading arms 26a, 26b comprises a linear loading machine that is swingably mounted in place.

The processing chamber 10 houses therein two bases 30, 32 for holding workpieces W thereon. The base 30, also referred to as a first base, which is closer to the first preliminary chamber 14a, is mounted on the lower end of a support post 34a of a slide mechanism 34 mounted on the ceiling panel of the processing chamber 10. The base 30 is horizontally movable in the processing chamber 10 by the operation of the slide mechanism 34. The base 32, also referred to as a second base, which is closer to the second preliminary chamber 14b, is mounted on a mount plate 36a of a pressing mechanism (bonding unit) 36 such as a fluid pressure cylinder device having a piston rod extending through the bottom panel of the processing chamber 10. The fluid pressure cylinder device is mounted on the lower surface of the bottom panel of the processing chamber 10. The base 32 is vertically movable in the processing chamber 10 by the pressing mechanism 36.

According to the present embodiment, the first base 30 is movable by the slide mechanism 34 between a first position close to the first preliminary chamber 14a and a second position close to the second preliminary chamber 14b, i.e., directly above the second base 32. Further, the slide mechanism 34 is capable of moving the first base 30 in directions normal to the sheet of FIG. 1. Therefore, it is possible to make fine adjustment for positioning bonding regions of workpieces W on the bases 30, 32. Each of the bases 30, 32 has a fixing means (not shown), such as an electrostatic chuck or the like, for holding the workpiece W and a built-in heater (heating portion) 38 for heating the workpiece W to a predetermined temperature.

The processing gas inlet pipe 22, which serves as a gas inlet, has an upstream end connected to a processing gas source and an inactive gas source (both not shown), and a downstream end connected to two ring-shaped gas ejection heads 40a, 40b that are positioned in vertically confronting relation to the bases 30, 32 in the processing chamber 10. The gas ejection heads 40a, 40b have a plurality of oblique ejection ports 42 defined in their inner surfaces for ejecting a processing gas toward the centers of the bases 30, 32. According to the present invention, the gas ejection heads 40a, 40b are disposed respectively in the first and second positions in the processing chamber 10. The gas ejection head 40b in the second position has an inside diameter greater than the size of the bases 30, 32 to allow the bases 30, 32 to move vertically through the inside of the gas ejection head 40b. Each of the ejection ports 42 may be in the form of a slit and may be directed in any desired direction and may have any desired size.

The processing chamber 10 has position detectors 44a, 44b positioned in confronting relation to the respective bases 30, 32 as they are located in the first and second positions. The position detectors 44a, 44b serve to recognize image patterns of the workpieces W to detect their positions, for example. The position detectors 44a, 44b are electrically connected to a controller, not shown, which actuates the slide mechanism 34 based on the positions of the workpieces W that are detected by the position detectors 44a, 44b, for thereby positioning the workpieces W horizontally in alignment with each other. The position detectors 44a, 44b and the slide mechanism 34, which serves as a position corrector, jointly make up a positioning mechanism. The controller not only controls the positioning of the workpieces W, but also controls overall operation of the bonding apparatus in terms of the temperature and pressure in the processing chamber 10 and the supply of the gas to the processing chamber 10.

Operation of the bonding apparatus will be described below.

According to the present embodiment, each of the workpieces W, to be bonded, has a plurality of bonding regions 46 of metal.

The processing chamber 10 has been evacuated to a certain vacuum by the evacuating device (pressure controller) 20. The bases 30, 32 have been heated to a temperature of 150° C., for example, by the heaters (heating portions) 38 incorporated in the bases 30, 32.

A nitrogen gas is introduced through the gas inlet pipe 24a into the first preliminary chamber 14a until an atmospheric pressure is developed in the first preliminary chamber 14a. Thereafter, the door 28a is opened, and a workpiece W is placed onto a hand 27 of the loading arm 26a in the first preliminary chamber 14a. At this time, the bonding regions 46 of the workpiece W are directed downwardly. The door 28a is closed, and the first preliminary chamber 14a is evacuated to a vacuum by the evacuating device 20. Thereafter, the gate valve 12a is opened, and the loading arm 26a is operated to deliver the workpiece W to a position directly below the first base 30 in the processing chamber 10. The loading arm 26a is angularly moved toward the first base 30, whereupon the workpiece W carried by the loading arm 26a is gripped by the fixing means, such as an electrostatic chuck or the like, on the first base 30. Another workpiece W is also brought from the second preliminary chamber 14b into the processing chamber 10 in the same process as described above. In the second preliminary chamber 14b, however, the workpiece W is gripped on the second base 32 with the bonding regions 46 of the workpiece W being directed downwardly.

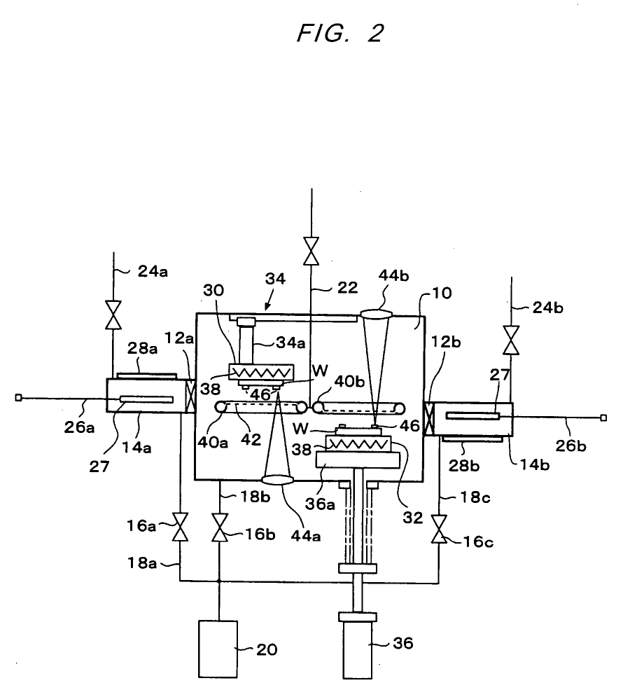

After the loading arms 26a, 26b are withdrawn from the processing chamber 10, the gate valves 12a, 12b are closed, and the processing chamber 10 is evacuated to a vacuum by the evacuating device 20. Then, as shown in FIG. 2, the position detectors 44a, 44b detect the positions of the bonding regions 46 of the workpieces W gripped by the bases 30, 32. Based on the detected positions, the controller moves the first base 30 horizontally in perpendicular X and Y directions and, if necessary, pivots the first base 30 in a ⊖ direction (rotational direction) so as to position the bonding regions 46 of the workpieces W in alignment with each other for their bonding.

Then, an organic acid gas as a processing gas is introduced from the processing gas inlet pipe (gas inlet) 22 into the processing chamber 10, and the evacuating device 20 is operated to keep a pressure of 400 Pa, for example, in the processing chamber 10. The two bases 30, 32 have been heated to 150° C. to raise the temperature of the workpieces W to about 150° C. If there is a thermal resistance between the bases 30, 32 and the workpieces W, then the thermal resistance may be measured in advance to determine the temperature difference therebetween, and the bases 30, 32 may be kept at a temperature higher than the workpieces W by the temperature difference. The organic acid of the processing gas should preferably be formic acid or acetic acid, for example.

An example in which a formic acid gas is used to bond bonding regions of copper formed on workpieces to each other will be described below. According to experiments conducted by the inventors, a copper oxide film having a thickness of 20 nm was removed under a pressure of 400 Pa at a substrate temperature of 150° C. in a processing time of 10 minutes. A copper oxide film having a thickness of 20 nm was removed under a pressure of 40 Pa at a substrate temperature of 300° C. in a processing time of 0.5 minute. It was confirmed that a natural copper oxide film having a thickness of several nm was removed under a pressure of 400 Pa at a substrate temperature of 100° C. in a processing time of 60 minutes. It is apparent that the oxide films can be removed for a shorter time under a higher pressure. The above conditions were applied when only the formic acid gas was introduced after the processing chamber was evacuated.

When a mixture of a formic acid gas and an inactive gas, typically a nitrogen gas, was used as a processing gas, it was confirmed that a natural copper oxide film was removed at a substrate temperature of 200° C. in a processing time of 3 minutes under a substantially atmospheric pressure with the processing gas including the formic acid gas having a pressure of 40 Pa in the processing chamber.

Then, the supply of the processing gas is stopped, and the processing gas is discharged from the processing chamber 10. If the mixture of a formic acid gas and a nitrogen gas was used as a processing gas, it was confirmed that no bonding strength difference was recognized when the supply of the formic acid gas was stopped and the workpieces were bonded with only the nitrogen gas within the processing chamber and when the supply of both the formic acid gas and the nitrogen gas was stopped and the workpieces were bonded after the formic acid gas and the nitrogen gas were discharged.

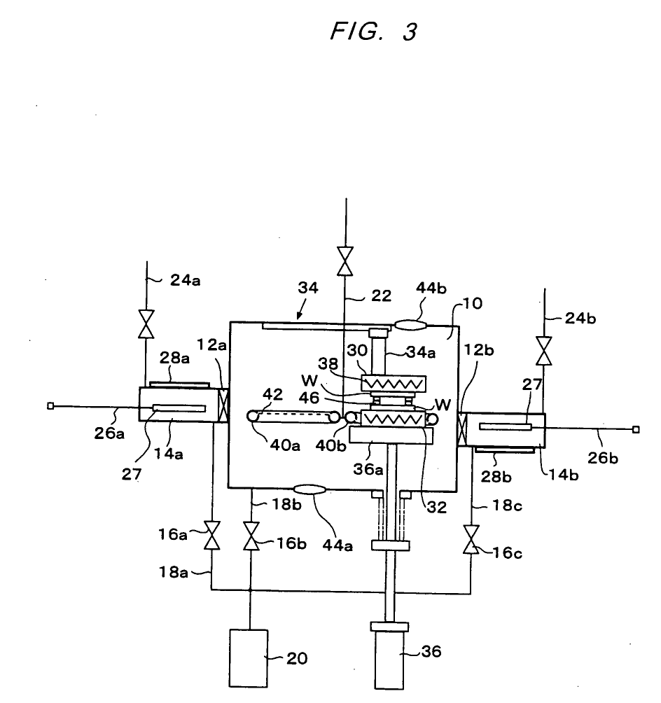

Then, the first base 30 is moved by the slide mechanism 34 to a position in exact facing alignment with the second base 32, after which the second base 32 is lifted by the pressing mechanism (bonding unit) 36 to press and bond the bonding regions 46 of the workpieces W, as shown in FIG. 3.

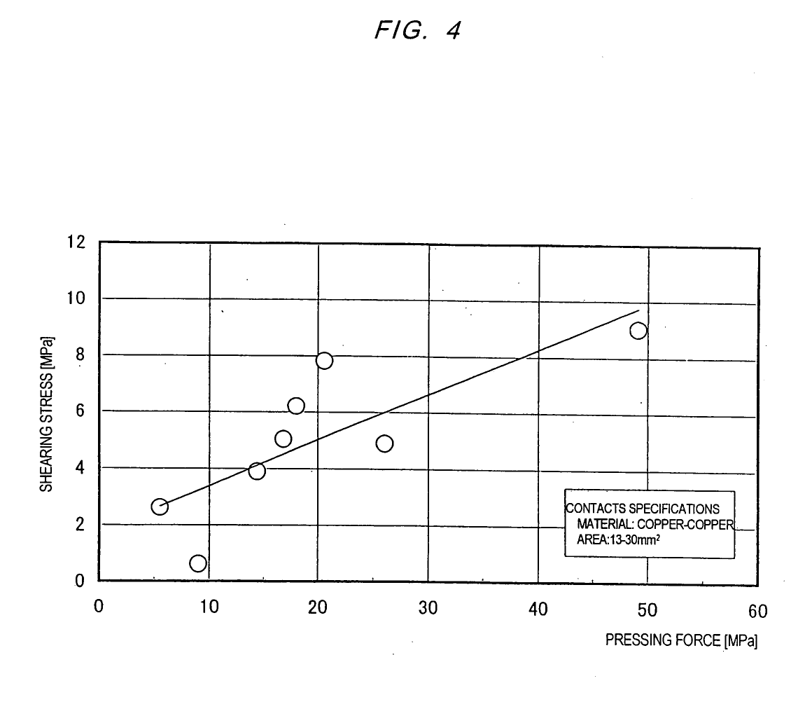

The inventors prepared a pair of members of copper as the bonding regions 46, and checked the relationship between the pressing force applied perpendicularly to the members and the shear fracture force produced when the members were pulled parallel to their planes after the pressing force was applied to the members, when the workpieces W were held at a temperature ranging from 120 to 150° C. The results are shown in FIG. 4. It can be seen from FIG. 4 that if the shear fracture force is 4 MPa or greater, then the necessary pressing force is 14 MPa or greater.

Therefore, it has been found that the temperature for cleaning the surfaces of the bonding regions and the temperature for bonding the bonding regions are substantially the same as each other. Consequently, the cleaning unit and the bonding unit may be placed in the same processing chamber, and the workpieces may be successively cleaned and bonded while they are being placed on the same bases. As a result, the bonded surfaces are prevented from being oxidized again and contaminated, the processing time can be shortened, the number of processing chambers can be reduced, and feed mechanisms can be dispensed with in the processing chamber. The workpieces can thus be bonded for higher quality, higher productivity, and lower costs.

After the pressing mechanism 36 is lowered, the bonded workpieces W, as described above, are delivered by the loading arm 26b into the second preliminary chamber 14b in which the temperature of the bonded workpieces W is lowered. After the pressure in the second preliminary chamber 14b is returned to the atmospheric pressure, the door 28b is opened, and the workpieces W are removed from the bonding apparatus. A series of the bonding processes are now finished. According to the above embodiment, the processing gas is ejected toward the two workpieces at different positions. However, the processing gas may be ejected toward the two workpieces at the same position as described below.

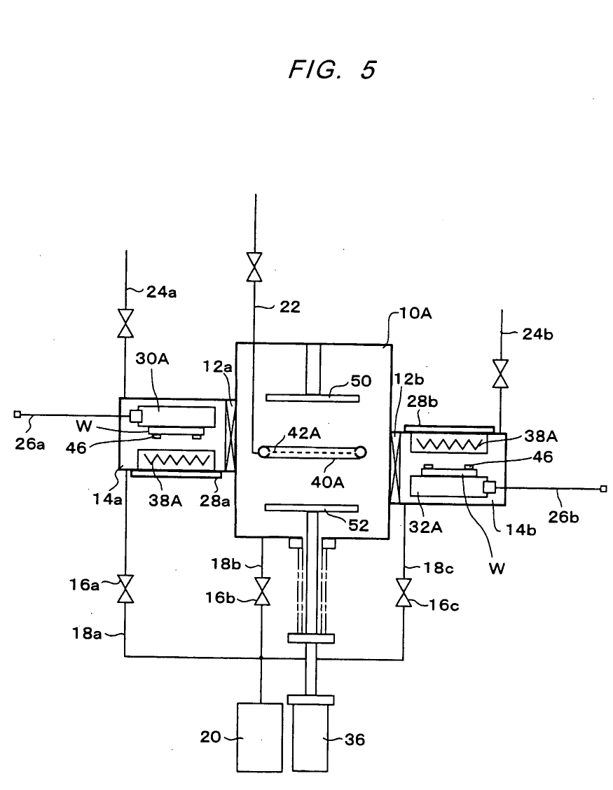

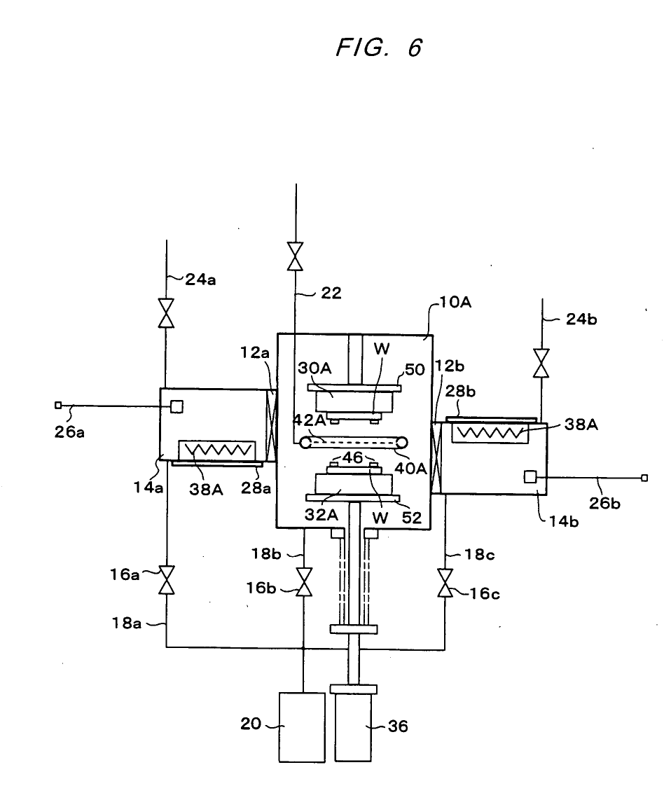

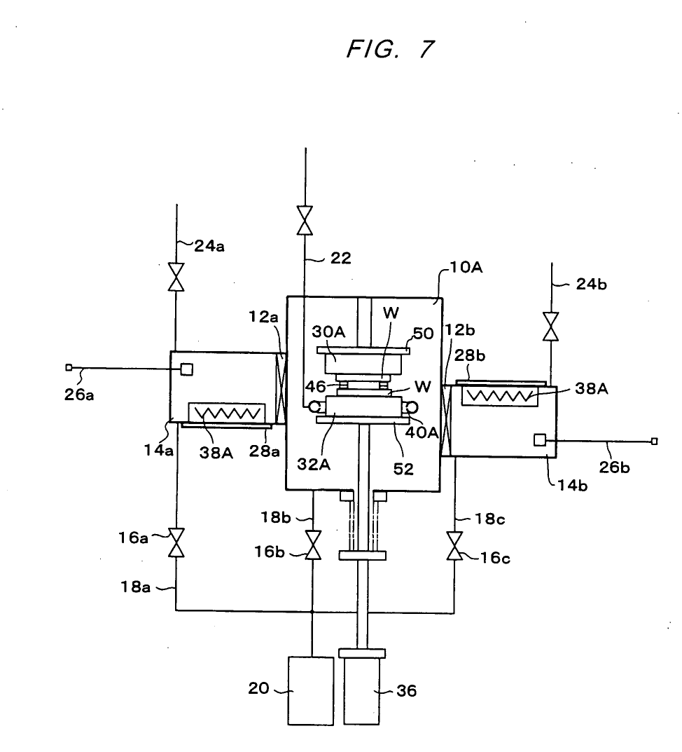

FIGS. 5 through 7 show a bonding apparatus according to a second embodiment of the present invention. According to the second embodiment of the present invention, the workpieces W are positioned outside of the processing chamber. Those parts of the bonding apparatus according to the second embodiment, which are identical or similar to those of the bonding apparatus according to the first embodiment, are denoted by identical or similar reference characters.

As shown in FIG. 5, a processing chamber 10A houses therein upper and lower support bases 50, 52 which face each other. The support bases 50, 52 do not move horizontally. The lower support base 52 is vertically movable by the pressing mechanism (bonding unit) 36. The processing chamber 10A also houses therein a single gas ejection head 40A having a plurality of horizontal ejection ports 42A. However, the ejection ports 42A may be oriented obliquely in upward and downward directions.

According to this embodiment, bases 30A, 32A are not fixedly mounted in the processing chamber 10A, but are movable between the processing chamber 10A and the left and right preliminary chambers 14a, 14b by the loading arms 26a, 26b. Heaters (heating portions) 38A are separate from the bases 30A, 32A, and are disposed on respective inner surfaces of the doors 28a, 28b of the preliminary chambers 14a, 14b. The surfaces of the bases 30A, 32A for placing the workpieces W thereon have marks or surface irregularities (positioning mechanism) serving as a positioning reference for placing the workpieces W properly on the bases 30A, 32A. The surfaces of the support bases 50, 52 for placing the bases 30A, 32A thereon also have marks or surface irregularities (positioning mechanism) serving as a positioning reference for placing the bases 30A, 32A properly on the support bases 50, 52. Therefore, the positioned workpieces W can easily be secured to the bases 30A, 32A, and the positioned bases 30A, 32A can easily be secured to the support bases 50, 52.

Operation of the bonding apparatus according to the second embodiment will be described below. The doors 28a, 28b of the preliminary chambers 14a, 14b are opened, and the workpieces W are mounted on the bases 30A, 32A supported on the loading arms 26a, 26b with the bonding regions 46 facing away from the bases 30A, 32A. At this time, the workpieces W are positioned with predetermined accuracy with respect to the positioning references on the bases 30A, 32A. Then, the doors 28a, 28b. are closed, and an inactive atmosphere is introduced into the processing chamber 10A. The bonding regions 46 are brought closely to the heaters 38A, and heated thereby to 150° C., for example. Thereafter, the gate valves 12a, 12b are opened, and the bases 30A, 32A are delivered into the processing chamber 10A by the respective loading arms 26a, 26b. The bases 30A, 32A are positioned and mounted on the respective support bases 50, 52.

Then, the loading arms 26a, 26b are withdrawn from the processing chamber 10A. A processing gas, such as a formic acid gas or the like, is introduced into the processing chamber 10A, and oxide films on the surfaces of the bonding regions 46 are removed under a predetermined gas pressure at a predetermined temperature in a predetermined processing time, as in the preceding embodiment. Then, the pressing mechanism 36 lifts the lower base 32A to press and bond the bonding regions 46 of the workpieces W mounted on the bases 30A, 32A against each other. The bonded workpieces W are removed from the bonding apparatus in the same manner as described above with respect to the first embodiment.

In the second embodiment, after the workpieces W are placed in reference positions on the bases 30A, 32A outside of the processing chamber, i.e., within the preliminary chambers 14a, 14b, the bases 30A, 32A are loaded into the processing chamber 10A. However, after the workpieces W are placed on the bases 30A, 32A, the bases 30A, 32A may be positioned outside of the bonding apparatus, and then loaded into the processing chamber 10A.

In the above embodiments, the workpieces are cleaned and bonded in the single processing chamber. However, the workpieces may be cleaned and bonded in respective processing chambers. According to such a modification, it is necessary to deliver the workpieces in a vacuum between the processing chambers, or to deliver the workpieces in an inactive atmosphere, whose humidify and oxygen concentration are controlled at certain levels or lower, between the processing chambers, for thereby preventing the cleaned bonding regions from being oxidized again.

According to the present invention, the cleaned bonding regions of the workpieces are bonded to each other under pressure while the bonding regions are being prevented from being deteriorated by oxidization and contamination. The workpieces can thus be bonded at a relatively low temperature through a single process for a strong, highly durable bond.

Although certain preferred embodiments of the present invention have been shown and described in detail, it should be understood that various changes and modifications may be made therein without departing from the scope of the appended claims.

What is claimed is:

1. A bonding apparatus comprising:
a hermetically sealed processing chamber;
a plurality of bases for holding at least two workpieces having respective bonding regions in said processing chamber;
a gas inlet for introducing a processing gas to clean said bonding regions into said processing chamber;
a pressure controller for controlling a predetermined pressure to be developed in said processing chamber;
a heater for heating said workpieces in said processing chamber; and
a bonding unit for pressing and bonding said bonding regions of said workpieces to each other in said processing chamber.

2. A bonding apparatus according to claim 1, further comprising:
a positioning mechanism disposed in said processing chamber for positioning said bonding regions with respect to each other.

3. A bonding apparatus according to claim 2, wherein said positioning mechanism comprises:
a position detector for detecting positions of said workpieces held by said bases; and
a position corrector for correcting the positions of said workpieces based on the positions detected by said position detector.

4. A bonding apparatus according to claim 1, further comprising:
at least one preliminary chamber, disposed adjacent to said processing chamber, for transferring said workpiece between an atmospheric environment and said processing chamber without exposing said processing chamber to the atmospheric environment.

5. A bonding apparatus according to claim 1, further comprising:
a positioning mechanism disposed outside of said processing chamber for positioning said bonding regions with respect to each other.

6. A bonding apparatus according to claim 1, wherein said processing gas comprises an organic acid gas such as a formic acid gas or an acetic acid gas, said bonding regions are cleaned at a temperature ranging from 100 to 300° C., and bonded at a temperature ranging from 120 to 300° C.

7. A bonding apparatus according to claim 6, wherein said bonding regions are cleaned under a pressure of at least 40 Pa developed in said processing chamber.

8. A bonding apparatus according to claim 1, wherein said processing gas comprises an organic acid and an inactive gas, and said bonding regions are cleaned under a substantially atmospheric pressure with said processing gas including said organic acid gas having a pressure of 40 Pa in said processing chamber.

9. A bonding apparatus according to claim 1, wherein said bonding regions are cleaned and bonded at substantially the same temperature.

10. A bonding apparatus according to claim 1, wherein said bonding regions are bonded under a pressure of at least 14 MPa.

11. A bonding apparatus according to claim 1, wherein said bonding regions are made of copper, oxide copper, or a copper alloy.

12. A bonding apparatus comprising:
a cleaning unit for holding at least two workpieces having respective bonding regions in a hermetically sealed processing chamber and introducing a processing gas into said processing chamber to clean said bonding regions;
a bonding unit for pressing and bonding said bonding regions of said workpieces to each other in said processing chamber; and
a loading unit for loading said workpieces from said cleaning unit into said bonding unit in said processing chamber.

13. A bonding apparatus according to claim 12, wherein said processing gas comprises an organic acid gas such as a formic acid gas or an acetic acid gas, said bonding regions are cleaned at a temperature ranging from 100 to 300° C., and bonded at a temperature ranging from 120 to 300° C.

14. A bonding apparatus according to claim 13, wherein said bonding regions are cleaned under a pressure of at least 40 Pa developed in said processing chamber.

15. A bonding apparatus according to claim 12, wherein said processing gas comprises an organic acid and an inactive gas, and said bonding regions are cleaned under a substantially atmospheric pressure with said processing gas including said organic acid gas having a pressure of 40 Pa in said processing chamber.

16. A bonding apparatus according to claim 12, wherein said bonding regions are cleaned and bonded at substantially the same temperature.

17. A bonding apparatus according to claim 12, wherein said bonding regions are bonded under a pressure of at least 14 MPa.

18. A bonding apparatus according to claim 12, wherein said bonding regions are made of copper, oxide copper, or copper alloy.

19. A bonding method comprising:
loading at least two bonding workpieces having respective bonding regions into a processing chamber;
heating said workpieces in said processing chamber and introducing a processing gas into said processing chamber to clean said bonding regions; and then
pressing and bonding said bonding regions of said workpieces to each other in said processing chamber.

20. A method according to claim 19, further comprising:
positioning said bonding regions with respect to each other within said processing chamber.

21. A method according to claim 19, further comprising:
positioning said bonding regions with respect to each other outside of said processing chamber.

22. A method according to claim 19, said processing gas comprises an organic acid gas such as a formic acid gas or an acetic acid gas, said bonding regions are cleaned at a temperature ranging from 100 to 300° C., and bonded at a temperature ranging from 120 to 300° C.

23. A method according to claim 22, wherein said bonding regions are cleaned under a pressure of at least 40 Pa developed in said processing chamber.

24. A method according to claim 19, wherein said processing gas comprises an organic acid and an inactive gas, and said bonding regions are cleaned under a substantially atmospheric pressure with said processing gas including said organic acid gas having a pressure of 40 Pa in said processing chamber.

25. A method according to claim 19, wherein said bonding regions are cleaned and bonded at substantially the same temperature.

26. A method according to claim 19, wherein said bonding regions are bonded under a pressure of at least 14 MPa.
